(19) United States
(12) Patent Application Publication
(10) Pub. No.: US 2022/0396679 A1
(43) Pub. Date: Dec. 15, 2022

(54) Method For Treatment Of Waste Material And Reactor System Thereof

(71) Applicant: loniqa Technologies B.V., Eindhoven (NL)

(72) Inventors: Joost Robert WOLTERS, Waalre (NL); Michael Josef DE GROOT, Dordrecht (NL); Andre Banier DE HAAN, Hoeven (NL); Egor Vasilyevich FUFACHEV, Utrecht (NL)

(73) Assignee: loniqa Technologies B.V., Eindhoven (NL)

(21) Appl. No.: 17/775,070

(22) PCT Filed: Nov. 6, 2020
(86) PCT No.: PCT/EP2020/081325

§ 371 Date: May 6, 2022

(30) Foreign Application Priority Data
Nov. 8, 2019 (NL) 2024194

(51) Int. Cl. C08J 11/10; B09B 3/70; B09B 3/40; B29B 17/02

(52) U.S. Cl. CPC C08J 11/10; B09B 3/70; B09B 3/40; B29B 17/02; C08J 2323/00; C08J 2367/00; C08J 2377/00; C08J 2371/00; C08J 2375/04; B09B 2101/75

(57) ABSTRACT

The reactor system comprises a reactor vessel with at least one inlet and a first and a second outlet, which reactor vessel is configured for depolymerisation of a condensation polymer and which first and second outlet are configured for removal of a first and a second part of a reaction mixture. The reactor system further comprises a heat exchanger downstream of the first outlet. Herein the second outlet is arranged at a lower position of the reactor vessel than the first outlet. The first outlet is configured for removal of the first part being a dispersion and/or solution comprising said condensation polymer and depolymerisation products thereof in a solvent. Said first part is led to the heat exchanger. The second outlet is configured for removal of the second part including agglomerates. The reactor system is used for depolymerisation of a condensation polymer.

### FIELD OF THE INVENTION

The invention relates to a method of recycling waste material comprising condensation polymer, said waste material being in solid form, which method comprises the steps of:
supplying said condensation polymer into a reactor vessel, wherein the condensation polymer constitutes a reaction mixture that further comprises a solvent and optionally a catalyst, wherein said solvent is selected to be a solvent for the condensation polymer and/or for reaction products obtained from said condensation polymer by depolymerisation;
heating said condensation polymer to a temperature of at least 150° C.;
depolymerising at least a portion of said condensation polymer in said reaction mixture into monomer, dimer, trimer and/or oligomer;

The invention further relates to a reactor system for recycling of waste material comprising condensation polymer.

### BACKGROUND OF THE INVENTION

It has been recognized that recycling of polymers in waste material is necessary, so as to prevent huge landfills and so as to make efficient use of raw materials. Polymers are used in a large variety in packaging, construction materials, textile and so on. Polymers are generally subdivided into polymers obtained by radical polymerisation and condensation polymers. The first group includes well-known members as polyolefins (such as polyethylene and polypropylene) and polyvinylchloride. The second group includes polyesters, polyamides, polyethers and polyurethanes. Well-known polyesters include polyethylene terephthalate (PET), polybutylene succinate and polylactic acid (PLA). Well-known polyamides include nylon-6 and nylon-6,6.

Packaging waste comprising a variety of bottles is nowadays collected separately and thereafter sorted in a pre-sorting and typically processed to flakes or other pieces with sufficiently small volume. The sorting herein is for instance carried out by optical recognition, based on information that a specific bottle is made of a certain material. As a consequence, it has become feasible to provide feed streams that largely comprise one or two types of polymer, such as polyethylene, polypropylene or PET. A specific feed stream can then be provided to a factory for processing into new raw material of specific quality. For polyolefins, such processing involves cleaning, sorting and mixing to specific product grades. For condensation polymers, such processing involves depolymerisation into monomer and the like.

It is known that the quality of the resulting circular raw material strongly depends on the removal of contaminants. These contaminants includes colorants and other additives such as fillers and plasticizers that may be present in the polymer material. These contaminants further include other mostly polymer material which could not be removed in the pre-sorting. Since the waste material tends to come from a variety of sources, even when being consumer packaging waste, still there is a significant unpredictability as to the amount of contaminants and the type of contaminants.

One way of dealing therewith is the performing of extensive cleaning and sorting of the feed. Such may be effective. However, it would give rise to significant costs for condensation polymers. After such thorough cleaning and sorting, condensation polymers still need to be depolymerised into monomers, dimers, oligomers and the like with sufficient yield. The useful raw material, typically the monomer, is then to be collected and crystallized. This raw material need itself to be cleaned thoroughly, for instance by filtration, treatment with activated carbon and/or ion exchange resins, as specified in EP1234812B1. Overall, the total costs of cleaning and sorting the feed and subsequent depolymerisation and purification of the monomer would render the entire process too expensive.

The process specified in EP1234812B1 is based on the depolymerisation by means of solvolysis, such as in ethylene glycol or diethylene glycol. An alternative process is proposed by the current applicant, for instance in WO2015/106200A1. This process involves catalysed depolymerisation followed by the addition of water or an aqueous solution. The monomeric product will enter the aqueous phase, whereas oligomers, catalyst and any additives remain in a second phase that becomes a slurry. The two phases are thereafter separated. The monomeric product can then be further purified and obtained by crystallisation. The second phase may be recycled so as to recover the catalyst and any oligomer therein.

Even though the catalysed depolymerisation of condensation polymers such PET does not appear sensitive to the presence of any contaminants, it is still required to take variations in the feed type (hereinafter also referred to feed quality) into account.

### SUMMARY OF THE INVENTION

It is therefore an object of the invention to provide a method of recycling such waste material predominantly comprising a condensation polymer that is capable of managing feed streams of waste material with different feed quality.

More particularly, it is an object to provide a method of recycling, wherein the condensation polymer that is decomposed into oligomer, dimer and monomer is a polyester, and preferably PET.

It is foreseen that pre-sorted waste material comprises at least 80 wt % or even at least 90 wt % polyester such as PET but still at least one further polymer material.

It is a further object of the invention to provide a reactor system with which said method can be performed.

According to a first aspect, the invention provides a method of recycling waste material comprising condensation polymer, said waste material being in solid form, which method comprises the steps of:
supplying said waste material into a reactor vessel, wherein the waste material constitutes a reaction mixture that further comprises a solvent and optionally a catalyst, wherein said solvent is selected to be a solvent for the condensation polymer and/or for reaction products obtained from said condensation polymer by depolymerisation;
heating said waste material to a temperature of at least 150° C., wherein said waste material is heated as part of the reaction mixture;
depolymerising at least a portion of said condensation polymer at said temperature in said reaction mixture into monomer, dimer, trimer and/or oligomer;
forming a first part and a second part of said reaction mixture in said reactor vessel, wherein said second part comprises agglomerates and said first part is more homogeneous than the second part;
separately removing said first part and said second part of said reaction mixture from said reactor vessel;
passing the first part of said reaction mixture through a heat exchanger for lowering its temperature; and
processing the cooled first part of the reaction mixture to obtain a predefined reaction product selected from said monomer, dimer, trimer and oligomer.

According to a second aspect, the invention provides a reactor system for recycling of waste material comprising condensation polymer suitable for depolymerisation and further polymer material that is not suitable for depolymerisation. The reactor system of the invention comprises a reactor vessel with at least one inlet and a first and a second outlet, which reactor vessel is configured for depolymerisation of a condensation polymer and which first and second outlet are configured for removal of a first and a second part of a reaction mixture. The reactor system as comprises a heat exchanger downstream of the first outlet. Herein the second outlet is arranged at a lower position of the reactor vessel than the first outlet. The first outlet is configured for removal of the first part being a dispersion and/or solution comprising said condensation polymer and depolymerisation products thereof in a solvent, which second outlet is configured for removal of the second part including agglomerates comprising said further polymer material.

It was found in investigations leading to the invention that the heat exchanger downstream of the depolymerisation reactor had a tendency of getting blocked and/or demonstrating malperformance. This issue occurred somewhat irregularly. It was subsequently discovered that the issue related to the feed quality and that it could be solved by separating the reaction mixture into a first part and a second part. The first part of the reaction mixture is at least largely liquid, being a dispersion or solution and can be passed through the heat exchanger. The second part of the reaction mixture comprises agglomerates. The amount and size of such agglomerates tends to vary in dependence of the feed quality.

The formation of agglomerates tends to be stimulated by the presence of polyolefin material, such as polypropylene and polyethylene. Such material has a melting temperature in the range of 100-140° C. It is believed by the inventors that the molten polyolefin material tends to act as an adhesive, binding solid materials together. This polyolefin material furthermore may precipitate inside the heat-exchanger, reducing efficiency and lifetime thereof. Contamination of pre-sorted waste PET with polyolefins may be expected, as many bottle caps are made of polyolefin. Solid material to which the molten polyolefin adheres could be solid pieces of PET, any other polymer material such as PVC and polystyrene which melt at higher temperatures, pieces of stone, glass, and/or metals such as aluminium, steel, copper, brass and nickel, and the like.

Due to the presence of agglomerates, the second part is found to have a higher density than the first part. As a consequence, in one preferred embodiment, the removal of the second part is done via a different outlet than the removal of the first part. Herein, the second outlet for the second part including agglomerates is arranged at a lower position on the reactor vessel than the first part. This has the further advantage that the first and the second outlet may be selected and configured to match the constituency of the reaction mixture parts that they are to transmit. More precisely, the first outlet is configured for removal of a predominantly liquid stream. Such predominantly liquid stream may be a dispersion or a solution. It is not excluded that it comprises flakes of PET or parts thereof, as long as these are mixed with the liquid stream. The first outlet (and the second outlet) may for instance be provided with means for creating an underpressure, so as to draw the first part of the reactor mixture out of the reactor vessel. As will be further understood, the first outlet (and the second outlet) is typically provided with a valve that preferably may be opened or closed under control by a controller.

The first outlet is for instance arranged at a position such that 60-90% of the volume of the reactor mixture may be removed via the first outlet. This will typically be at a height above the bottom of the reactor of at least 10%, preferably at least 15% or also at least 20% of the total height of the reactor vessel. The exact position is open to further design, and may be in any of the ranges of 60-75%, 70-85% or 75-90%. It will depend on the shape of the reactor vessel, the expected residence time for the first part, arrangement of stirrer means, the type of reactor vessel (being either a batch reactor or a continuous reactor system).

In a further embodiment, the reactor vessel is provided with a third and optionally a fourth outlet, wherein the first, third and fourth outlet are arranged at mutually different heights relative to the second outlet, that is arranged at a lower position. Herein, the first, third and fourth outlet are selectively opened in dependence on feed type and/or processing settings. According to this embodiment, the effective position of the outlet for the first part may be reconfigured. More preferably, this is carried out under control of a controller and by using valves. Hence, when a higher concentration of agglomerates is expected or even observed, then the volume of the first part may be reduced by selecting an outlet that is located at a higher position. Hence, also feed streams with lower feed quality can be processed. If so desired, any further outlet may also be arranged at a corresponding height as the first outlet, so as to increase flow rate out of the reactor vessel.

The second outlet is configured for removal of a stream including agglomerates. Preferably, the second outlet is arranged at a bottom of the reactor vessel. However, it is not excluded that the second outlet is arranged at a bottom part of the reactor vessel, for instance at a side wall portion close to the bottom. The latter could for instance be useful, when stirrer means for the reactor comprises a shaft extending into the reactor vessel from the bottom side. Furthermore, an arrangement at a side wall may be preferred, so as to achieve transport of the second part in a rather horizontal direction rather than a vertical direction. In further implementations, such active transport is created by means of pneumatic displacement, by means of a rotary feeder, such as a scooper, by means of a screw, by means of piston means. The piston means may comprise a piston which is reciprocally slidable within a piston housing. According to another option the piston means could be rotational piston means rotating within a piston housing. In again a further implementation, the second outlet is provided with pressure generation means, so as to push the second part out of the reactor. It is observed for clarity that such active transport may be used, and such means for active transport be present regardless of whether the second outlet is arranged at a bottom of the reactor vessel or rather at a bottom part of a side wall of the reactor vessel.

In a preferred implementation, the reactor vessel is provided with stirring means, so as to achieve adequate mixing. Such stirring means may be implemented in various manners. The stirrer means may comprise mixing blades connected to a shaft. The stirrer means may further comprise a frame-like construction with vertical and horizontal shafts. The stirrer means may further comprise screw type elements, so as to move solid material upwards. It is furthermore not excluded that liquid material is pushed into the reactor vessel from a bottom side, so as to generate an upward stream. In again a further implementation, the reactor vessel may be a fluidized bed reactor, provided with an inlet for carrier gas so as to generate upwards flow.

In again a further embodiment, the reactor vessel is provided with a barrier extending between an upper part and a lower part. The barrier is configured such that an aperture is present for exchange between the upper part and the lower part. In one implementation, the barrier has a shape of an annular ring. In a further implementation, the barrier extends from a sidewall of the reactor vessel, but does not extend along the full circumference of the sidewall. Rather, it constitutes a rim, rib, blade or plate or body. Preferably, the barrier is arranged at the side of the first outlet. Generally, the barrier is arranged at a height between said first outlet. Optionally, the barrier may be open for fluid, for instance by being porous and/or comprising a sieve with a predefined mesh. The physical subdivision of the first reactor into an upper part and a lower part is deemed to limit the flow of agglomerates through the first outlet. This is deemed most relevant, though not exclusively, for the case wherein the first reactor vessel is operated as a continuous reactor rather than as a batch reactor that in which stirring means may be switched off so as to enable settling of the agglomerates. The physical subdivision moreover enables a different treatment of the first part of the reaction mixture that is substantially without agglomerates and the second part of the reaction mixture with agglomerates. Such different treatment may be a different residence time, different flow regime, different orientation of the stirring means, so as to optimize mixing in certain areas. Preferably, the lower part and the upper part are each provided with separate stirring means.

For sake of clarity, it is observed that the subdivision in accordance to the invention is principally not limited to a lower part and an upper part with a single intermediate barrier. If so desired, one or more intermediate parts may be defined, mutually distinguishable for instance by means of barriers and/or by means of flow regimes (as for instance implemented by means of stirrers).

In one embodiment, the first part is removed from the reactor vessel after a first residence time, and the second part is removed from the reactor vessel after a second residence time, wherein the first residence time is different from the second residence time. Herewith the processing conditions of the first and the second parts may be optimized, in view of degree of depolymerisation, limitation of agglomerate size, optimum removal conditions.

In one implementation hereof, the residence time of the second part may be shorter than that of the first part. This is believed to the useful so as to remove agglomerates early, and to prevent further growth of agglomerates. In a further embodiment hereof, the second part may thereafter be processed and at least partially recycled into the reactor vessel. In addition to the agglomerates, the second part will also contain mixtures of condensation polymer, depolymerisation products, solvent and catalyst. By means of recycling the depolymerisation of the condensation polymer can continue. Furthermore, any condensation polymer within an agglomerate may be depolymerised to a larger extent. Examples of processing include a separation of agglomerates or a breaking of agglomerates. Breaking of agglomerates could be achieved by grinding or by passing the stream through a raster or sieve. Separation may be achieved by passing through a separator, but also by decantation in a vessel or otherwise.

In another implementation hereof, the residence time of the first part is shorter than that of the second part. This is believed to be useful , when the mixing in the bottom part of the reactor vessel is less than that in the remainder. By extending the residence time of the second part, the degree of depolymerisation can be brought to an acceptable level. It is considered that such may even decrease an amount and/or size of agglomerates, in that condensation polymer that is part of the agglomerates would dissolve and/or depolymerize. In another option, this implementation is used, in combination with an arrangement wherein the first part is transferred to a further reactor vessel for further depolymerisation. The first part then resides in the—first—reactor vessel for heating up and for removal of any other polymer material. In one implementation hereof, the temperature in the first reactor vessel may then be lower than the temperature in the further reactor vessel. Such lower temperature in the first reactor vessel may be sufficient to ensure dissolution of the condensation polymer while limiting the formation and/or growth of agglomerates.

The temperature in the first reactor vessel is preferably in the range of 170-200° C. for depolymerisation of polyester and more particularly PET. Most effective temperatures for depolymerisation are in the range of 190-200° C., in combination with the use of ethylene glycol as a solvent. The temperature for dissolution of PET into the solvent such as ethylene glycol could be achieved in the range of 120-180° C., for instance 150-180° C.

Preferably, the second part is processed, after leaving the reactor vessel, to obtain a predefined reaction product selected from said monomer, dimer, trimer and oligomer, as part of which processing the agglomerates are removed and/or decomposed. Said processing may include transportation into the downstream vessel. It may alternatively or additionally comprise recycling at least part of the second part into the reactor vessel, optionally with an intermediate process step, such as removal of agglomerates. The processing may further include a separation step to remove agglomerates, such as by means of filtration. The processing may again include a step of pushing the stream with agglomerates through a grid or other breaking means. In this pushing step, the agglomerates may be broken down due to pressure development in order to pass the grid. The grid may be selected in a desired roughness, and more particularly with a size smaller than that of any processing tools located downstream thereof. Such processing tools may also include a heat exchanger.

In a further embodiment, the processing of the second part comprises recycling of the second part, or a portion thereof, into the reactor vessel. Transportation of the second part out of the reactor is considered an effective way so as to render the second part more uniform and enable access thereto by catalyst and/or solvent for further depolymerisation. The mixing into the reactor vessel will further contribute thereto. Beyond reducing size of agglomerates, the recycling is expected to lead to depolymerisation of condensation polymer within the second part. Moreover, in one preferable implementation, it may be beneficial that the depolymerisation in the first reactor vessel is terminated prior to full depolymerisation into monomer and dimer. As a consequence hereof, the second part may comprise still degradable polymer material. The first part will comprise a mixture of monomers, dimers, trimers and oligomers. The remaining polymer material and oligomers with significant chain length can be depolymerized during recycling.

In one implementation, the second part is recycled in its entirety. In another implementation, the second part is divided into two streams, for instance by means of any conventional Y-shaped splitter. In again a further implementation, the second part may be separated into two parts, or the second part may be divided selectively, for instance by removal of more solid portions with higher density.

In again a further implementation hereof, the second part is recycled to a second reactor vessel, which may also be a settling vessel. After further depolymerisation in the second reactor vessel, the depolymerisation product(s) can be recycled into the first reactor vessel. Remaining waste can be removed, for instance via one or more waste outlets in the second reactor vessel, and more preferably after settling in this second reactor vessel. In one further implementation, the second reactor vessel may be provided with cooling means so as to ensure that waste can be removed at an appropriate processing temperature and/or such that the settling may result in different phases that can be easily separated. One way of cooling that is deemed preferred is via the addition of feed at a lower temperature than the reaction temperature, for instance at room temperature. Feed includes here solvent and/or waste polymer material.

In another embodiment, the cooled first part and the second part, or a portion thereof, of the reaction mixture are combined in a downstream vessel. This embodiment is deemed advantageous so as to minimize loss of condensation polymer, solvent, depolymerisation products and/or catalyst. In the implementation where the second part is partially recycled, only a portion thereof may enter the downstream vessel. Otherwise, it is deemed preferable that the second part is entirely transferred to the downstream vessel. Within the downstream vessel, the second part will be cooled down by contact with the first part. Further cooling may be provided in such downstream vessel, so as to bring the reaction mixture at a temperature for separation and purification.

In a preferred implementation the method comprises the further steps of mixing water or an aqueous solution with said reaction mixture in said downstream vessel, resulting in a first aqueous phase comprising monomer and dimer, and a second phase comprising oligomer, catalyst complex and agglomerates, and separating the first phase from the second phase. This has turned out an effective manner to remove various contaminants. Furthermore, the catalyst, to the extent that it is not dissolved in the solvent but heterogeneous, can be recovered to a large extent. The separation occurs for instance in a centrifuge. The presence of any agglomerates is deemed advantageous, as it may render the phase separation more effective. In a preferred implementation hereof, the second phase is processed to reduce its water content and thereafter recycled into the reactor vessel. The reduction of water content may be carried out in several ways, for instance by means of evaporation, such as by distillation and/or membrane distillation. Additionally solids in the second phase may be separated from the alcoholic solvent.

In a further embodiment, the feed stream of waste material comprising condensation polymer is preferably in the form of flakes or pellets, for instance with a volume of 5.10⁻⁶-0.5 cm³, more preferably 5.10⁻⁴-0.05 cm³. If the feed stream would be provided in larger sizes, a size reduction step may be carried out, for instance by shredding and/or grinding. In a preferred implementation, the waste material is substantially dry, and more particularly has a water content as low as reasonably possible, for instance less than 5 wt %, preferably less than 3 wt %, more preferably less than 1 wt %.

In one embodiment, a washing pre-treatment is performed on the flakes or pellets. Such washing may be carried out with water or an aqueous solution. The water or aqueous solution may herein be heated, for instance to 30-70° C., more preferably 35-55° C. The washing may occur in a bath, wherein the flakes or pellets are transported on a band running through the water. The washing may alternatively or additionally be carried out by spraying of the flakes. Most preferably, the flakes or pellets are thereafter dried. Such drying may be carried out by exposure to the atmosphere, on a running band and/or in drying equipment, by means of air, preferably heated air.

The reactor vessel is suitably configured for a volume in the range of 0.1-100 m³, such as 10-50 m³. This is deemed sufficient to enable a feed flow rate in the order of 10-100 kton/year. Whereas the description so far referred to a reactor vessel, it is not excluded that a plurality of reactor vessels are arranged in series. The plurality may for instance include 2 up to 6 vessels. Rather than a single vessel, a cascade of vessels may be applied. The cascade may have one or more feedback loops. Clearly, when a plurality of vessels is used in parallel or in series, the average volume per vessel may be decreased, if so desired.

The condensation polymer is more preferably one of a polyester, polyamide, polyurethane and polyether, the latter also including starch and cellulose based polymers. Polyesters are preferred, and polyethylene terephthalate (PET) is currently commercially the most important polyester. PET may include further comonomers, such as iso-BHET, to improve its properties, as known in the art. Other polyesters are however not excluded. Examples include so-called biodegradable polymers, such as polylactic acid (PLA), polybutylene terephthalate (PBT), polycyclohexylenedimethylene-2,5-furandicarboxylate (PCF), polybutylene adipate-co-terephthalate (PBAT), polybutylene sebacate-co-terephthalate (PBSeT), polybutylene succinate-co terephthalate (PBST), polybutylene 2,5 furandicarboxylate-co-succinate (PBSF), polybutylene 2,5-firandicarboxylate-co-adipate (PBAF), polybutylene 2,5-furandicarboxylate-co-azelate (PBAzF), polybutylene 2,5 furandicarboxylate-co-sebacate (PBSeF), polybutylene 2,5-furandicarboxylate-co-brassylate (PBBrF), polybutylene 2,5-furandicarboxylate (PBF) , polybutylene succinate (PBS), polybutylene adipate (PBA), polybutylne succinate-co-adipate (PBSA), polybutylene succinate-co-sebacate (PBSSe), polybutylene sebacate (PBSe), and copolymers thereof, for instance copolymers with polylactic acid and/or PET.

It is generally deemed preferable that depolymerisation of condensation polymers is catalysed by means of a catalyst. The choice of the catalyst depends among others on the condensation polymer and further processing of the reaction mixture after depolymerisation. For PET, the applicant has achieved good results with functionalized nanoparticles and aggregates thereof, such as disclosed in WO2017/111602A1, which included herein by reference. The functionalisation herein comprises a ionic liquid type functionalization, for instance an imidazolium. Such ionic liquid functionalization may be coupled to the nanoparticle by means of silanol or carboxylic acid functional groups. However, alternative catalysts are by no means excluded. Examples of other catalysts include metal salts, such as iron salts, such as Fe-acetate and iron oxides (FeₓO_{y}), titanium salts, such as titanium butoxide, zinc salts such as zinc acetate, and other salts such as magnesium oxide, sodium carbonate and potassium carbonate.

Depolymerisation of polyesters occurs more preferably by means of solvolysis, wherein the solvent acts as reactant. Typical solvents are alkanols and alkanediols, such as ethylene glycol, methanol, diethylene glycol, propylene glycol, dipropylene glycol. Ethylene glycol has been found suitable in view of its physical properties (such as the boiling point around 200° C.). For the depolymerisation of PET, the use of ethylene glycol leads to bis(2-hydroxyethyl) terephthalate (BHET) as primary depolymerisation product. Dimers, trimers and further oligomers may also be obtained. BHET as well as its dimer may be purified and obtained by crystallisation in sufficient purity. One method thereof resides in the processing of the aqueous phase obtained after adding water and/or an aqueous solution in the downstream vessel and separation thereof from a second phase in a centrifuge, as hereinabove mentioned. The ratios of polymer, solvent and catalyst are not critical. Examples are specified in the above mentioned WO2017/111602, included by reference.

It is observed for clarity that any embodiment or implementation discussed hereinabove is applicable to any of the aspects covered in the present application.

### BRIEF INTRODUCTION OF THE FIGURES

These and other aspects of the method and the reactor system of the invention will be further elucidated with reference to the figures, which are purely diagrammatical in nature and not drawn to scale, wherein:

FIG. 1 shows a first embodiment of the reactor system;

FIG. 2 shows a second embodiment of the reactor system;

FIG. 3 shows a third embodiment of the reactor system,

FIG. 4 shows a fourth embodiment of the reactor system,

FIG. 5 shows an implementation of a reactor vessel for use in the reactor system;

FIG. 6 shows a fifth embodiment of the reactor system.

### DETAILED DESCRIPTION OF ILLUSTRATED EMBODIMENTS

In the following, equal or corresponding parts in different figures will be referred to with equal reference numerals. The illustrated embodiments are intended for explanation and illustration and are not intended to limit the scope of the claims.

FIG. 1 shows the reactor system 100 according to a first embodiment, which comprises a reactor vessel 10 provided with an inlet 11, a first outlet 21 and a second outlet 22. The reactor vessel 10 is configured for depolymerisation of condensation polymers, while allowing other material to be separated from the first outlet 21 hereof. Such other material for instance comprises polyolefins, possibly other radical-polymerized polymers such as PVC and polystyrene as well as metal, glass and stone. An example of metal that has been found back is aluminium. Also other condensation polymers than the one to be depolymerised are examples of such other material. These other materials tend to form agglomerates during heating up of the reaction mixture in the reactor vessel 10. It is believed, without desiring to be bound therewith that molten polyolefins may herein acts as glue holding said aggregates together. Also the primary condensation polymer to be degraded in solid form may be part of the aggregate. The primary condensation polymer is PET in a preferred embodiment. However, the invention is by principle not limited to the depolymerisation of PET. The same approach can be applied to other polyesters.

The reactor system 100 shown in FIG. 1 is configured as a batch system, wherein the reactor vessel 10 is provided with polymer material, solvent and catalyst prior to the start of the depolymerisation reaction. The polymer material, solvent and catalyst constitute a reaction mixture, of which the composition changes in the course of the depolymerisation: at least part and suitably at least 95%, more preferably at least 99% of the primary condensation polymer such as PET, is depolymerized into oligomers, trimers, dimers and monomers. The waste material loaded into the reactor vessel 10 via an inlet 11 is typically in the form of flakes with dimensions as mentioned hereinabove. The solvent added thereto is preferably ethylene glycol. The catalyst is for instance based on an ionic-liquid functionalized magnetic nanoparticle or aggregate thereof. Preferred magnetic nanoparticles are iron oxide particles and cobalt-iron oxide particles. The presence of other metals in addition to iron and/or cobalt is not excluded. The aggregate of the magnetic nanoparticles is suitably porous and more preferably has dimensions that allow separation in a centrifuge 60. When using an alternative catalyst, such catalyst is again preferably chosen with a size allowing the separation thereof in a centrifuge 60. The polymer material is preferably loaded into the reactor vessel 10 in a ratio with the solvent in the range of 10:1 to 1:10. The order of adding the components (catalyst, waste material and solvent) is not relevant. It appears beneficial that the catalyst is added as a dispersion in solvent. Furthermore, the solvent may be pre-heated. The reactor system 100 could alternatively be elaborated as a continuous system. It seems therein suitable to make use of a cascade of reactors. Also for a continuous system wherein flow from one vessel to another is required, it is very important that forming of uncontrollable agglomerates is prevented. As such, the invention also finds use therein.

As shown in this FIG. 1, the reactor vessel 10 is provided with a first outlet 21 and a second outlet 22, wherein the first and second outlet 21, 22 are respectively configured for removal of a first part (or first stream) 31 and a second part (or second stream) 32 of the reaction mixture. The first part 31 is predominantly liquid and is transferred by means of pump 41 to a heat exchanger 40. The resulting cooled first part 39 is fed into a downstream vessel 50, which is provided with a further inlet 51 for the addition of water or an aqueous solution. The second part 32 of the reaction mixture is also fed into the downstream vessel 50. However, it bypasses the heat exchanger 40, so as to avoid that agglomerates block the heat exchanger 40 and/or that other material such as polyolefins would precipitate inside the heat exchanger 40. The heat exchanger 40 is for instance configured for heat exchange with a solvent stream, that is subsequently fed to the reactor vessel 10 via the inlet 11. However, alternative implementations are not excluded. The FIG. 1 further shows valves 27-29 that are present for controlling the flow of the first and second streams 31, 32. It will be understood that such valves are under control of a controller, which is not shown.

The downstream vessel 50 is in the illustrated embodiment provided with mixing means as schematically indicated to ensure adequate mixing of the cooled first part 39, the second part 32 and the water or aqueous solution. Typically such mixing means include a mixing chamber and a stirrer in whatever form. However, a stirrer may not be strictly necessary in dependence on the flow regime of the cooled first part and/or the second part. In one preferred embodiment, the cooled first part may be supplied as a turbulent stream, and a mixing chamber without stirrer turns out sufficient. It is observed for sake of completeness that the mixing chamber is preferably part of the downstream vessel, but may alternatively be implemented as a chamber upstream of the downstream vessel 50. The downstream vessel 50 may then be configured so as to achieve a pre-separation. In such pre-separation, heavy solids such as sand and metal with a density higher than that of the alcoholic solvent may be removed via a bottom outlet. Material with a lower density than the alcoholic solvent may be removed via a top outlet, such as a skimmer. To achieve such a pre-separation, it is preferred that the flow in the downstream vessel 50 becomes laminar up to silent. In case that the mixing chamber is part of the downstream vessel 50, it is preferably separated from the said bottom outlet and/or top outlet via a pervious plate, such as a perforated plate.

The water or aqueous solution herein acts as coolant. It may be provided at ambient temperature or any higher temperature and is preferably liquid. Still, it is not excluded that separate cooling means are provided, and/or that the resulting stream would pass another heat exchanger downstream of the vessel 50. Due to the addition of water or an aqueous solution, two phases will appear, of which the first is an aqueous phase comprising solvent, monomer and at least some dimer and trimer. The second phase is a slurry comprising a variety of solids, including catalyst, oligomers, trimers and the solvent. The phases are separated in the centrifuge separator 60, resulting in a first phase 61 that is further processed to obtain a depolymerised product, such as BHET, and a second phase 62 that is recycled. In the FIG. 1, the second phase 62 is shown to be directly recycled to the reactor vessel 20, but it could alternatively be processed so as to remove said other material. In one embodiment, the second phase 62 comprises alcoholic solvent, more preferably ethylene glycol, water, oligomer, colorants and (heterogeneous) catalyst. In one implementation, the processing comprising a distillation step so as to reduce the water content of the second phase. Preferably, the second phase 62 is fed back into the reactor vessel 20 with a water content of less than 10 wt. %, more preferably less than 5 wt. % or less than 2wt. %., or even less than 1%. The further processing of the first phase 61 comprises for instance a treatment with active carbon and one or more crystallisation treatments, so as to arrive at crystalline material of a raw material suitable for polymerisation. Most preferably, the raw material is BHET, but it is further feasible to collect crystalline dimer.

In accordance with the invention, a stream 32 with agglomerates will leave the reactor vessel 10 via the second outlet 22. They thereafter do not pass the pump 41 and the heat exchanger 40. Preferably, as shown in FIG. 1, the stream 32 with agglomerates will be led into the downstream vessel 50. Therewith, the heat exchanger 41 can be dimensioned without taking account of the agglomerates, which may have an unpredictable size. This facilitates increase of efficiency of the heat exchanger, and furthermore facilitates increase in flow rate through the heat exchanger. In this manner, it has becomes feasible to achieve a flow rate of 20-40 m³/hour through the heat exchanger 41 and still achieving a temperature decrease of 40-80° C., such as 50-60° C. . It is herein observed that the increased efficiency of the heat exchanger 41 again enables that the stream 32 with agglomerates would enter the downstream vessel 50 without any cooling while nevertheless enabling control of the temperature in the downstream vessel 50. In a further implementation, a temperature sensor is present in the downstream vessel 50 that is coupled to a controller configured to control the heat exchanger. In a further implementation, a further heat exchanger is provided to cool down the stream 32 with agglomerates. Such a further heat exchanger is then configured so that agglomerates will not block the heat exchanger. For instance, use can be made of a heat exchanger with a tube size of 40 mm or more, preferably 60 mm or more.

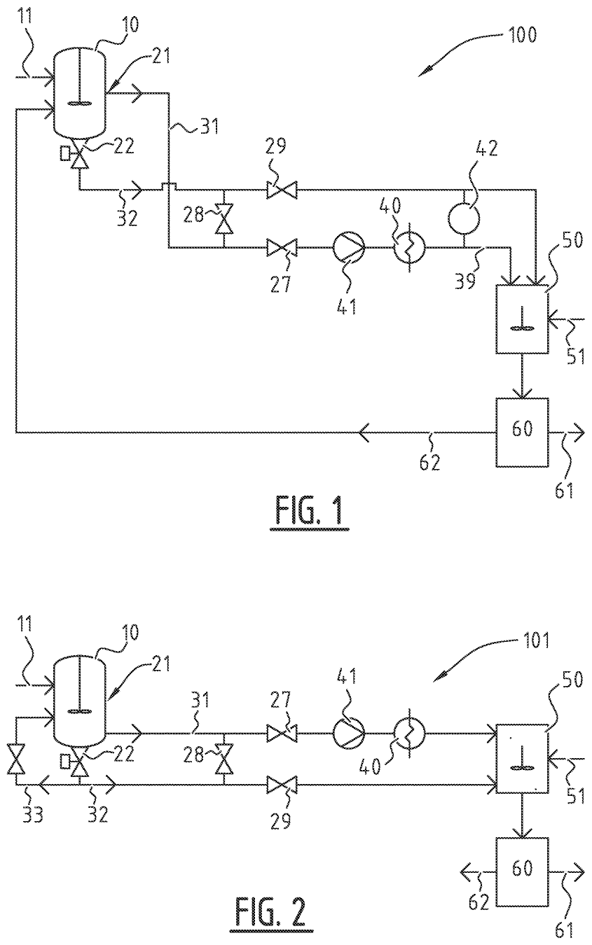

FIG. 2 shows the reactor system 101 according to a second embodiment. The set-up of this embodiment corresponds to that of the reactor system 100 according to the first embodiment. It will however be understood that the components used for implementation therein, such as valves 27-29, pump 41 may be modified. Furthermore, in the embodiment of FIG. 2, as of FIG. 1, the second part 32 is again mixed with the cooled first part 39 in the mixing vessel. It is not excluded that the processing of the first and second part 31, 32 would be performed separately, so as to prevent the first part 31 being contaminated with the other material collected in the second part 32.

In comparison to the first embodiment 100 of the reactor system, the reactor system 101 according to this second embodiment, is provided with a feed-back loop 33 for the second part 32. The feed-back loop 33 is added so as to recycle the second part 32 and allow that a larger portion of any condensation polymer therein is depolymerised into the desired depolymerisation products. The addition of such feed-back loop 33 furthermore is a manner so as to transport the second part 32. It is deemed that such transportation and the subsequent mixing with the first part in the reactor vessel 10 will homogenize the second part 32 and therewith prevent endless growth of agglomerates. As a consequence of the feed-back loop 33, it becomes feasible that the residence time of the second part 32 in the reactor vessel 10 is shortened. In the shown second embodiment, it is feasible that the second part 32 is returned to the reactor vessel 10 only partially. This is done as a safety measure, so as to enable removal of any major agglomerates. If desired, it is not excluded that an optical sensor system is implemented, at a bottom part of the reactor vessel 10 or rather in the pipes downstream of the second outlet 22. While a camera system is deemed preferably, one might alternatively use a window as sensor system. The second outlet 22 is in this second embodiment, and preferably also in the first embodiment, provided with means so as to actively remove the second part from the reactor vessel 10. A variety of active transportation means can be used, for instance an overpressure.

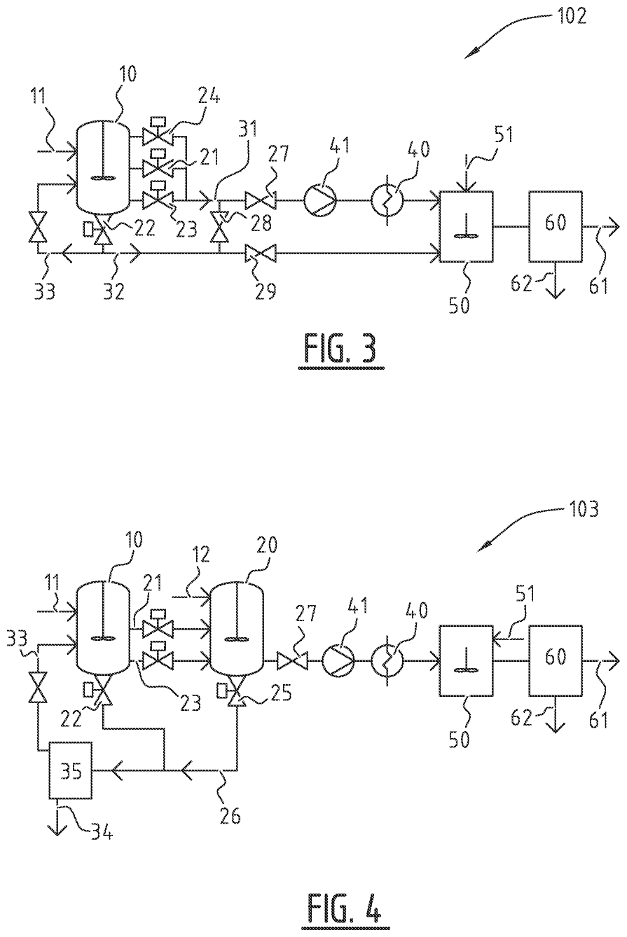

FIG. 3 shows a third embodiment of the reactor system 102. According to this third embodiment, the reactor vessel 10 is provided with additional outlets 23, 24, via which the first part 31 may be removed (or may leave) the reactor vessel 10. As shown in this FIG. 3, the additional third outlet 23 and fourth outlet 24 are arranged at different heights relative to the bottom of the reactor vessel 10 and thus relative to and above the second outlet 22 for the second part 32. While not shown, it will be understood that the said outlets 21-24 are under control of a controller and may thus be selectively opened and closed. As a consequence, it becomes feasible to modify which portion of the reactor volume of the reactor vessel 10 is deemed to be used for the first part 31, that will pass the heat exchanger 40 and which portion is to be used for the second part 32 that may be recycled and/or will bypass said heat exchanger 40. The provision of multiple outlets 21, 23, 24 for the first part 31 furthermore allows to increase the speed at which the first part 31 is removed from the reactor vessel 10. The choice of the outlets 21, 23, 24 for instance depends on the feed quality of the feed stream: the higher the content of other material, and/or the combination of other materials, as known from experience or based on some analysis prior to processing, the larger will be the risk for agglomerates and hence the larger the portion of the reactor volume needed for the second part 32. It is observed that the selective use of one or more of the multiple outlets 21, 23 and 24 may further be configured to change in the course of the residence time in the reactor vessel 10. Some portions of the first part 31 could be removed quickly. Furthermore, upon recycling of the second part 32 via the feedback loop 33, the portion of the reactor volume for the second part 32 might change over time. For the latter reason, this third embodiment is shown as an improvement of the second embodiment 101 and also includes the feedback loop 33 for the second part 31. However, this is not strictly necessary, and the improvement of multiple outlets 21, 23, 24 for the first part 31 may be implemented also in a system 100 without feedback loop 33. The locations of the multiple outlets is open to further design . The height of an outlet may be defined in terms of reactor volume percentage below an outlet. In an exemplary embodiment with three outlets, suitable heights are for instance 20-30%, 45-50% and 60-75%, wherein the upper outlet at 60% may be arranged for a larger flow rate.

FIG. 4 shows a fourth embodiment 103 of the reactor system. This embodiment is characterized in that a second reactor vessel 20 is present downstream of the-first-reactor vessel 10 and upstream of the heat exchanger 40. The second reactor vessel 20 is fed with the first part 31 only. Thereto, the first reactor vessel 10 is provided with a first and a third outlet 21, 23 on different heights. Each of these outlets is connected to a line giving separate access to the second reactor vessel 20, without intermediate combination thereof This is an implementation and is deemed useful for optimal control of the composition of the reacting mixture in the second reactor vessel 20. However, it is not deemed essential, and other options (with more outlets and/or with combination of multiple outlets into a single inlet to the second reactor vessel 20) are not excluded. The second reactor vessel 20 is furthermore provided with an inlet 12 via which fresh reactants can be added, such as solvent and catalyst. It is not excluded that the second reactor vessel 20 is also fed with more polymer material. In a further implementation, it can be arranged that depending on feed quality, waste material is added either to the first reactor vessel 10 or to the second reactor vessel 20. The first reactor vessel 10 is herein then a pre-treatment intended for more heavy feed.

The second reactor vessel 20 is furthermore provided with a first outlet 27 and a second outlet 25 at different heights and intended for a first part and a second part. The provision hereof is deemed to enable flexible use of the reactor system, but it might not be technically necessary. Instead hereof, a single outlet could be sufficient, which would be led to the heat exchanger 40. Also, while the present embodiment shown in FIG. 4 indicates that all of the second outlet 25 is recycled, this is not deemed strictly necessary. A partial feedback, for instance in the manner shown in FIG. 2 is feasible as well. Further variations may be apparent to a skilled person and are not excluded. More particularly, in the implementation shown in FIG. 4, the second part leaving the second reactor vessel 20 via the second outlet 25 is returned to the feedback loop 33 of the first reactor vessel 10. This is merely an advantageous implementation, but it is not excluded that the second part would be recycled to the second reactor vessel 20 instead. In the shown implementation, the feedback loop 33 comprises a basin or vessel 35. This vessel 35 is intended for sedimentation of heavy parts such as agglomerates within the second part. More fluid matter is herein taken from an upper portion of the vessel 35 and recycled to the first reactor vessel. The sedimented heavy parts may be removed via waste outlet 34 and be processed and disposed. The processing hereof for instance includes cooling and further removal of solvent.

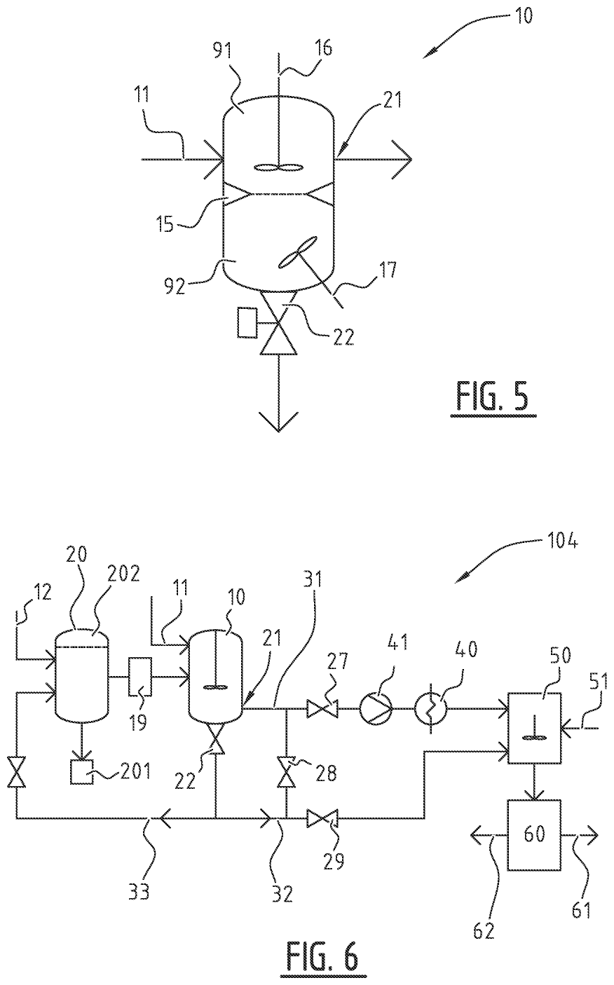

FIG. 5 shows an implementation of the reactor vessel 10. Rather than being a conventional substantially cylindrical vessel—as indicated in FIG. 1-4—the reactor vessel 10 of this implementation comprises a physical barrier 15 between an upper part 91 and a lower part 92 of the reactor vessel. In this implementation, the upper part 91 and the lower part 92 are each provided with a separate stirring means 16, 17. These stirring means 16, 17 may be embodied as known per se, as stirrer connected via a shaft to a motor (not shown), or as any type of mixer. It may be advantageous that the stirring means 17 of the lower part 92 is arranged such that the shaft extends sidewise or from a corner as schematically shown in FIG. 5. Such might be beneficial so as to prevent that agglomerates would stick in or around a corner or at a sidewall of the lower part. In this context, it is not excluded that more than one stirrer is arranged in the lower part 92. However, this is merely one embodiment. Vertically arranged stirrers could be used alternatively. More importantly, the presence of separate stirrer means in the upper part 91 and the lower part 92 is considered advantageous for several reasons. First of all, since any agglomerates will mostly be present in the lower part 92, the stirrer means 17 in the lower part 92 can be embodied in a more robust way, so as to provide adequate force for mixing a slurry including agglomerates. Secondly, this furthermore enables to ensure that both the upper part and the lower part are adequately mixed. Thirdly, the stirring means 17 in the lower part 92 may be implemented (and/or driven) so as to enable upwards flow. This would be beneficial so as to allow that smaller particles and also fluid parts may move out of the lower part 92 into the upper part 91. Fourthly, the stirring means 16, 17 may be driven in mutually different manners, so as to set a different flow regime. Preferably, the conditions are set such that the flow in the upper part 91 is less turbulent than the flow in the lower part 92. While some turbulence in the upper part 91 is deemed advantageous, it is not excluded that the flow in the upper part 91 would not be turbulent, or would only be turbulent intermittently, i.e. by variation of stirring power.

The barrier 15 can be embodied in several ways and its location may be specified in accordance with further design. Thus, while the figure indicates that the volume of the upper part 91 and the lower part 92 is substantially equal, the volume ratio between upper part 91 and lower part 92 is generally in the range of 5:1 to 1:3. It seems preferable, however, that the upper part 91 has a larger volume than the lower part 92, so that the volume ratio is more preferably in the range of 5:1 to 1:1, for instance 3:1 to 1:1. The barrier 15 is shown in the FIG. 5 as a body that locally reduces the width of the reactor vessel 10 (and thus creates an aperture of limited width. Said aperture may for instance have a width of 30-80% of the width of the reactor vessel 10. In one implementation, the barrier 15 may be closed. In another implementation, the barrier may be open to fluid flow, for instance as a porous body and/or as a sieve. It is deemed most practical that the barrier 15 is implemented as an insert within the reactor vessel 10. However, it is not excluded that use is made of a separate reactor vessels for the first and the second part 91, 92, which reactor vessels are connected by means of a tube, and mutually arranged such that agglomerates would be flowing under the effect of gravity from the first vessel (upper part 91) towards the second vessel (lower part 92). Moreover, while the figure indicates that the barrier 15 is annular, it is not excluded that the barrier would have a smaller angular extension. More particularly, the barrier 15 may be arranged at the side of the outlet 21 and be absent at the side of the inlet 11.

It is observed for sake of clarity that the reactor vessel as shown in FIG. 5 may be combined with any of the reactor systems 101-104 as presented with reference to the Figures, but also more generically with the reactor system as specified in the claims and discussed in the introduction.

It is further observed that the reactor vessel 10 as shown in FIG. 5 may be further provided with a plurality of outlets 21, 23, 24 as shown in FIG. 3 and FIG. 4. It is not even excluded that such a further outlet is arranged in the lower part 92. If desired, a sieve could be present so as to avoid flow of agglomerates via the said further outlet.

FIG. 6 shows a fifth embodiment of the reactor system 104 according to the invention. In this fifth embodiment, as in the fourth embodiment 103 shown in FIG. 4, a first reactor vessel 10 and a second reactor vessel 20 are present. The second reactor vessel 20 is however not arranged downstream of the first outlet 21 of the first reactor vessel 10, but downstream of the second outlet 22 and within a loop 33 that goes back into the first reactor vessel 10. As such, the object of the second reactor vessel 20 in this fifth embodiment is to achieve further depolymerisation for the second part of the reaction mixture that includes agglomerates. In a preferred embodiment hereof, the depolymerisation in the first reactor vessel 10 is performed merely partially, so that polymers and/or oligomers with a comparatively long chain length are still present. It is not excluded that even some portions of the polymer material have not yet been dissolved. It has been found in experiments leading to this embodiment of the invention, that a lower degree of depolymerisation is advantageous for the separation in the centrifuge 60 after the addition of water as a phase separation additive in the mixing vessel 50.

The first part that is sufficiently depolymerised is then removed for the downstream treatment so as to arrive at depolymerisation products in a suitable form. Preferably, the depolymerisation products in a suitable form are depolymerisation products in a sufficiently pure form, for which colorants, catalyst and any other additives and ions have been removed to a predefined level. The second part comprising agglomerates and polymers and/or oligomers is recycled to the second reactor 20 for further depolymerisation. At least one further inlet 12 is present in the second reactor vessel 20. This may for instance be configured for inlet of solvent, catalyst, more waste material. The second reactor vessel 20 is herein provided with a main outlet towards the first reactor vessel 10. A buffer vessel 19 is preferably arranged between the outlet of the second reactor vessel 20 and the inlet of the first reactor vessel 10. Instead or in addition of a buffer vessel 19 a filter could be present between the second reactor vessel 20 and the first reactor vessel 10.

The second reactor vessel is further provided with outlets 201, 202 for waste. The outlet 201 is an outlet for waste that has a higher density than the solvent used. This may include metal, sand, wood, glass, other inorganic material, possibly mixed and agglomerated together with polymer material that could not be degraded. The outlet 202 is an outlet for waste that has a lower density than the solvent used. Such waste for instance comprises polyolefins. An implementation hereof is for instance a skimmer.

In one implementation of the reaction system and the use thereof for depolymerisation, the second reactor vessel 20 is arranged as a batch reactor. This may be beneficial for ensuring that all the condensation polymer that can be depolymerised, will be depolymerised. In a further implementation, that is deemed most preferred with a second reactor vessel for batch operation, the second reactor vessel 20 is further arranged with means for cooling. This enables to cool down the waste to temperatures at which the waste can be more effectively be removed than at the depolymerisation temperature which is for instance in the range of 170-200° C. Such cooling means are for instance embodied as a heat removing shell around the reactor vessel 20. The shell may include a channel around the reactor vessel through which a cooling fluid such as water may flow. Alternatively, a separate heat exchanger may be present, and material residing in the second reactor vessel 20 may be led through the heat exchanger and recycled into the second reactor vessel 20.

In a further alternative implementation, the cooling means are embodied in that the further inlet 12 is configured for the provision of material at lower temperature than the reaction temperature (hereinafter also referred to as cooling material). The lower temperature may be room temperature, but may alternatively be any temperature between room temperature and the reaction temperature. The cooling material is for instance solvent and/or waste material to be depolymerised. It is observed that the lowering of the temperature will decrease the rate of depolymerisation. In one embodiment, therefore, the cooling material is provided after a predefined residence time of recycled material in the second reactor vessel 20. As such, the cooling material is supplied via the further inlet 12 so as to fill up to a predefined level the second reactor vessel 20. It is observed for sake of clarity that any of the alternative implementations of the cooling means may also be used in combination with each other.

While it is not explicitly shown in the FIG. 5, the second reactor vessel 20 is preferably provided with stirring means, such as a stirrer. However, such stirring means could be absent or be configured to be switched off This is deemed beneficial so as to use the second reactor vessel 20 as a settling vessel. The use as a settling vessel facilitates the removal of the waste via the waste outlets 201, 202.

Furthermore, rather than a single inlet port, the further inlet 12 may be provided so as to distribute the supplied material (including cooling material) in the second reactor vessel 20, for instance by means of distributed inlet ports and/or sprayers.

Thus, in summary, the invention relates to a reactor system comprises a reactor vessel with at least one inlet and a first and a second outlet, which reactor vessel is configured for depolymerisation of a condensation polymer and which first and second outlet are configured for removal of a first and a second part of a reaction mixture. The reactor system further comprises a heat exchanger downstream of the first outlet. Herein the second outlet is arranged at a lower position of the reactor vessel than the first outlet. The first outlet is configured for removal of the first part being a dispersion and/or solution comprising said condensation polymer and depolymerisation products thereof in a solvent. Said first part is led to the heat exchanger. The second outlet is configured for removal of the second part including agglomerates. The invention further relates to the use of the reactor system for depolymerisation of a condensation polymer.

1. A method of recycling waste material comprising condensation polymer, said waste material being in solid form, which method comprises the steps of:
supplying said waste material into a reactor vessel, wherein the waste material constitutes a reaction mixture that further comprises a solvent and optionally a catalyst, wherein said solvent is selected to be a solvent for the condensation polymer and/or for reaction products obtained from said condensation polymer by depolymerisation;
heating said waste material to a temperature of at least 150° C., wherein said waste material is heated as part of the reaction mixture;
depolymerising at least a portion of said condensation polymer in said reaction mixture at said temperature into monomer, dimer, trimer and/or oligomer;
forming a first part and a second part of said reaction mixture in said reactor vessel, wherein said second part comprises agglomerates and said first part is more homogeneous than the second part;
separately removing said first part and said second part of said reaction mixture from said reactor vessel;
passing the first part of said reaction mixture through a heat exchanger for lowering its temperature;
processing the cooled first part of the reaction mixture to obtain a predefined reaction product selected from said monomer, dimer, trimer and oligomer.

2. The method as claimed in claim 1, wherein the waste material furthermore comprises polyolefin material, which is molten during said heating step and/or said depolymerisation step, and wherein said polyolefin material becomes part of said agglomerates.

3. The method of claim 1, wherein the waste material comprises at least 80 wt %, preferably at least 90 wt % condensation polymer.

4. The method of claim 1, wherein the condensation polymer is chosen from the group of polyesters, polyamides, polyethers and polyurethanes, and is more preferably a polyester.

5. The method of claim 1, wherein the second part of the reaction mixture has a higher density than the first part.

6. The method of claim 1, wherein the reactor vessel is provided with a first and a second outlet, which are respectively used for the removal of the first and second part of the reaction mixture and wherein the second outlet is arranged at a lower position of the reactor vessel than the first outlet.

7. The method of claim 6, wherein
the reactor vessel is provided with a third and optionally a fourth outlet, wherein the first, third and fourth outlet are arranged at mutually different heights relative to the second outlet, that is arranged at a lower position, and
the first, third and fourth outlet are selectively opened in dependence on feed type and/or processing settings.

8. The method of claim 1, wherein the removal of the first part occurs after a different residence time than the removal of the second part.

9. The method of claim 1, wherein the removal of the second part of the reaction mixture comprises applying a pressure.

10. The method of claim 1, wherein the processing of the second part comprises recycling of the second part, or a portion thereof, into the reactor vessel.

11. The method of claim 1, wherein the cooled first part and at the second part, or a portion thereof, of the reaction mixture are combined in a downstream vessel, and preferably comprising the steps of
mixing water or an aqueous solution with said reaction mixture in said downstream vessel, resulting in a first aqueous phase comprising monomer and dimer, and a second phase comprising oligomer, catalyst complex and agglomerates, and
separating the first phase from the second phase.

12. The method of claim 1, wherein the second part is processed after leaving the reactor vessel to obtain a predefined reaction product selected from said monomer, dimer, trimer and oligomer, as part of which processing the agglomerates are removed and/or decomposed.

13. A reactor system for recycling of waste material comprising condensation polymer suitable for depolymerisation and further polymer material that is not suitable for depolymerisation comprising:
a reactor vessel with at least one inlet and a first and a second outlet, which reactor vessel is configured for depolymerisation of a condensation polymer and which first and second outlet are configured for removal of a first and a second part of a reaction mixture; and
a heat exchanger downstream of the first outlet;
wherein the second outlet is arranged at a lower position of the reactor vessel than the first outlet,
wherein the first outlet is configured for removal of the first part being a dispersion and/or solution comprising said condensation polymer and depolymerisation products thereof in a solvent,
which second outlet is configured for removal of the second part including agglomerates comprising said further polymer material.

14. The reactor system as claimed in claim 13, wherein the second outlet is provided with means for generating pressure, so as to push the second part out of the reactor vessel.

15. The reactor system of claim 13, wherein a feedback loop is arranged between the second outlet and an inlet of the reactor vessel for recycling at least part of the second part.

16. The reactor system of claim 13, further comprising a further reactor vessel downstream of the first outlet and upstream of the heat exchanger, wherein said further reactor vessel is configured for further depolymerisation of said condensation polymer and/or oligomeric reaction products thereof.

17. The reactor system of claim 13, further comprising a downstream vessel downstream of said heat exchanger, wherein the second outlet is coupled to said downstream vessel, and wherein preferably a separator is provided for separating a first phase and a second phase generated in said downstream vessel.

18. The reactor system of claim 13, wherein the reactor vessel is provided with a third and optionally a fourth outlet, wherein the first, third and fourth outlet are arranged at mutually different heights relative to the second outlet, that is arranged at a lower position, and wherein a controller is present for selectively opening the first, third and/or fourth outlet in dependence on feed type and/or processing settings.
